(19) United States
(12) Patent Application Publication
(10) Pub. No.: US 2019/0016009 A1
(43) Pub. Date: Jan. 17, 2019

(54) WOOD TREATMENT METHOD

(71) Applicants: Dow Global Technologies LLC, Midland, MI (US); Rohm and Haas Company, Collegeville, PA (US)

(72) Inventors: Kevin B. Vargo, Collegeville, PA (US); David M. Laganella, Swedesboro, NJ (US)

(73) Assignees: Dow Global Technologies LLC, Midland, MI (US); Rohm and Haas Company, Collegeville, PA (US)

(21) Appl. No.: 16/068,192

(22) PCT Filed: Feb. 15, 2017
(86) PCT No.: PCT/US17/17847

§ 371 Date: Jul. 5, 2018

Related U.S. Application Data
(60) Provisional application No. 62/301,108, filed on Feb. 29, 2016.

(51) Int. Cl. B27K 3/52; B27K 3/22; B27K 3/15

(52) U.S. Cl. CPC B27K 3/52; B27K 3/153; B27K 3/22

(57) ABSTRACT

A method for treating wood. The method comprises adding to wood: (a) a copper-containing wood preservative; and (b) a solution copolymer which is an acrylic polymer comprising from 5 to 40 wt % polymerized units of a nitrogen heterocycle monomer and from 30 to 80 wt % polymerized units of a monomer comprising at least one acid group or comprising at least 2 polymerized units of ethylene oxide.

The present invention relates to a wood treatment method in which wood is treated with a soluble copolymer composition and at least one copper-containing wood preservative.

Wood treated with the current copper-based wood preservatives tends to leach copper into the environment too easily. A method for controlling copper leaching has been disclosed, e.g., in U.S. Pat. No. 7,842,656. However, this method requires two separate treatments, one with a wood preservative and another with a latex copolymer.

The problem addressed by this invention is to reduce leaching of copper from wood containing copper-based preservatives.

### STATEMENT OF THE INVENTION

The present invention is directed to a method for treating wood. The method comprises adding to wood: (a) a copper-containing wood preservative; and (b) a solution copolymer which is an acrylic polymer comprising from 5 to 40 wt % polymerized units of a nitrogen heterocycle monomer and from 30 to 80 wt % polymerized units of a monomer comprising at least one acid group or comprising at least 2 polymerized units of ethylene oxide.

### DETAILED DESCRIPTION OF THE INVENTION

Treatment of wood is performed by contacting the wood with the copolymer described herein, preferably under conditions specified in AWPA Standards T1-05, N1-04, N2-04 and references cited therein. Preferably, the amount of copolymer in the aqueous solution used to treat the wood (as wt % of solution) is at least 0.05%, preferably at least 0.1%, preferably at least 0.3%, preferably at least 0.5%. Preferably, the amount of copolymer is no more than 5%, preferably no more than 3%, preferably no more than 2%, preferably no more than 1.5%, preferably no more than 1%. Preferably, the copper-containing wood preservative and the solution copolymer are added to the wood together in a single aqueous treatment solution. Preferably, the amount of copper (as copper metal) in the treatment solution is from 100 to 15,000 ppm, preferably at least 500 ppm, preferably at least 600 ppm;

preferably no more than 12,000 ppm, preferably no more than 5,000 ppm, preferably no more than 3,000 ppm. Preferably, the aqueous treatment solution has a pH of at least 7, preferably at least 8, preferably at least 9; preferably no more than 10.

Unless specified otherwise, all percentages are weight percentages (wt %), all temperatures are in ° C. and all operations are performed at room temperature (20-25° C.). The term “copolymer” refers to polymers polymerized from at least two different monomers. The term “solution copolymer refers to a copolymer produced via solution polymerization and which is not in the form of a latex, or aqueous emulsion. The term “aqueous” means water and mixtures composed substantially of water and water miscible solvents, preferably at least 50% water, preferably at least 75%, preferably at least 90%, preferably at least 95%. The use of the term “(meth)” followed by another term such as acrylic, acrylate, acrylamide, etc., refers to, for example, both acrylic and methacrylic; acrylate and methacrylate; acrylamide and methacrylamide; etc. The term “nitrogen heterocycle monomer” refers to a heterocyclic nitrogen compound (i.e., at least one nitrogen atom is in the heterocyclic ring) having from four to twenty carbon atoms and at least one vinyl group. The term “acrylic polymer” refers to a polymer having at least 70 wt % polymerized residues of acrylic monomers, preferably at least 80 wt %, preferably at least 90 wt %, preferably at least 95 wt %, preferably at least 98 wt %, preferably at least 99 wt %. Acrylic monomers include (meth)acrylic acids and their C₁-C₂₂ alkyl, hydroxyalkyl or polyethylene glycol esters; crotonic acid, itaconic acid, fumaric acid, maleic acid, maleic anhydride, (meth)acrylamides, (meth)acrylonitrile and alkyl or hydroxyalkyl esters of crotonic acid, itaconic acid, fumaric acid or maleic acid.

Preferably, the solution copolymer is soluble in water at room temperature at least to the extent of 1 wt %, preferably at least 2 wt %, preferably at least 3 wt %, preferably at least 5 wt %.

Preferably, the nitrogen heterocycle monomer comprises an aromatic nitrogen heterocycle. Preferably, the nitrogen heterocycle monomer has from four to ten carbon atoms. Preferred nitrogen heterocycle monomers include vinylimidazoles, vinylimidazolines, vinylpyridines, vinylpyrroles, vinylpyrrolidones and vinylcaprolactams; preferably vinylimidazoles and vinylpyridines; preferably 1-vinylimidazole, 2-vinylpyridine and 4-vinylpyridine; preferably 1-vinylimidazole. The copolymer may contain more than one nitrogen heterocycle monomer.

An “acid group” is a functional group selected from the group consisting of carboxylic acids, organosulfuric acids, sulfonic acids and phosphonic acids. Preferably, an acid group is a carboxylic acid functional group. Preferably, a monomer comprising at least one acid group has from three to ten carbon atoms, preferably three to six. Preferably, a monomer comprising at least one acid group is (meth)acrylic acid, itaconic acid, maleic acid or fumaric acid; preferably (meth)acrylic acid.

Preferably, the copolymer comprises at least 8 wt % polymerized units of a nitrogen heterocycle monomer, preferably at least 10 wt %; preferably no more than 35 wt %, preferably no more than 30 wt %, preferably no more than 27 wt %, preferably no more than 24 wt %. Preferably, the copolymer comprises at least 33 wt % polymerized units of a monomer comprising at least one acid group or comprising at least 2 polymerized units of ethylene oxide, preferably at least 36 wt %; preferably no more than 73 wt %, preferably no more than 67 wt %, preferably no more than 60 wt %, preferably no more than 55 wt %, preferably no more than 50 wt %. Preferably, the copolymer comprises at least 33 wt % polymerized units of a monomer comprising at least one acid group, preferably at least 36 wt %; preferably no more than 60 wt %, preferably no more than 55 wt %, preferably no more than 50 wt %, preferably no more than 45 wt %. Preferably, the copolymer comprises at least 40 wt % polymerized units of a monomer comprising at least 2 polymerized units of ethylene oxide, preferably at least 45 wt %, preferably at least 50 wt %, preferably at least 55 wt %; preferably no more than 77 wt %, preferably no more than 74 wt %. Preferably, the copolymer comprises a monomer comprising at least 2 polymerized units of ethylene oxide, preferably at least 3 units; preferably no more than 20 units, preferably no more than 15 units, preferably no more than 10 units. The number of units is a number average.

Preferably, the copolymer further comprises at least 15 wt % and preferably no more than 65 wt % polymerized units of additional monomers which are vinyl esters or acrylic monomers not having an acid group or nitrogen heterocycle and which have from three to twelve carbon atoms (preferably three to ten); preferably at least 20 wt %, preferably at least 27 wt %; preferably no more than 55 wt %, preferably no more than 50 wt %, preferably no more than 48 wt %, preferably no more than 44 wt %. Preferably, the copolymer comprises from 15 to 65 wt % polymerized units C₁-C₈ alkyl (meth)acrylate monomers, preferably at least 20 wt %, preferably at least 27 wt %; preferably no more than 55 wt %, preferably no more than 50 wt %, preferably no more than 48 wt %. Preferably, alkyl (meth)acrylate monomers are C₁-C₄ alkyl (meth)acrylate monomers. Preferably, alkyl (meth)acrylate monomers are alkyl acrylate monomers.

The copolymer is produced via solution polymerization, preferably in a solvent comprising water and C₁-C₄ alcohols. Preferably the solvent comprises at least one alcohol selected from the group consisting of ethanol, methanol, isopropanol, n-propanol. Preferably, the solvent comprises 25-75% water and 25-75% C₁-C₄ alcohols. Preferably, an organic peroxide is used as an initiator.

Preferably, the copolymer has a weight-average molecular weight (Mw) from 1,000 to 100,000; preferably no greater than 70,000, preferably no greater than 50,000, preferably no greater than 35,000; preferably at least 3,000, preferably at least 5,000.

The copolymer may comprise polymerized units derived from one or more crosslinkers. Crosslinkers include, e.g., multi-ethylenically unsaturated monomers, e.g., 1,4-butanediol diacrylate; 1,4-butanediol dimethacrylate; 1,6-hexanediol diacrylate; 1,1,1-trimethylol propane triacrylate; 1,1,1-trimethylol propane trimethacrylate; allyl methacrylate; divinylbenzene; and N-allyl acrylamide. Preferably, the copolymer comprises no more than 0.2 wt % polymerized units of crosslinkers, preferably no more than 0.1 wt %, preferably no more than 0.05 wt %, preferably no more than 0.02 wt %, preferably no more than 0.01 wt %.

Preferably, the copper-containing wood preservative contains at least 0.1% copper. Preferably, wood is treated to attain a minimum level of 0.1% copper, based on the weight of dry treated wood. Preferably, the maximum level of copper in the wood is 1.5%. [Preferred copper-containing wood preservatives include copper azole, copper monoethanolamine complex, copper ACQ, copper HDO, IMPRALIT KDS, versions of these preservatives that contain micronized copper, or combinations thereof. In one embodiment of the invention, the preservative is copper azole or copper ACQ.

### EXAMPLES

### Example 1: Polymer Synthesis

A polymer product was prepared using the following process:

(a) 200 proof ethanol (56.4 g), isopropanol (95%) (3.0 g), deionized (DI) water (56.4 g), ammonium hydroxide (28% as ammonia) (6.1 g), 1-vinylimidazole (1.35 g), glacial acrylic acid (1.8 g), and butyl acrylate (1.35 g) was charged to a 1 liter reactor equipped with a stirrer, dropping funnel and a condenser set at −5° C.;
(b) The contents were heated to reflux at 90° C. with agitation;
(c) A mixture of butyl acrylate (27.05 g), 1-vinylimidazole (27.05 g) and glacial acrylic acid (36 g) were added to the kettle over a period of 3 hours at a rate of 0.500 mL/min. Simultaneously, 1-amyl peroxypivilate (Trig 125-C-75) (2 g) in 200 proof ethanol (30.2 g), DI water (30.2 g), isopropanol (95%) (1.6 g), and ammonium hydroxide (28% as ammonia) (3.3 grams) was fed to the kettle at a rate of 0.4 mL/min for a period of 3 hours. The contents were maintained at 90° C. with agitation;
(d) The product of (c) was maintained at 90° C. with constant agitation for 60 minutes;
(e) 1-amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.496 mL/min for 30 minutes;
(f) The product of (e) was maintained at 90° C. with constant agitation for 30 minutes;
(g) 1-amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.496 mL/min for 30 minutes;
(h) The product of (g) was maintained at 90° C. with constant agitation for 60 minutes;
(i) The heading source was removed and the product of (h) was allowed to cool to room temperature resulting in the polymer product with 30% 1-vinylimidazole at 32.2% solids referred to as Polymer 1.

### Example 2: Polymer Synthesis

A polymer product was prepared using the following process:

(a) 200 proof ethanol (56.4 g), isopropanol (95%) (3.0 g), DI water (56.4 g), ammonium hydroxide (28% as ammonia) (6.1 g), 1-vinylimidazole (0.9 g), glacial acrylic acid (1.8 g), and butyl acrylate (1.8 g) was charged to a 1 liter reactor equipped with a stirrer, dropping funnel and a condenser set at −5° C.;
(b) The contents were heated to reflux at 90° C. with agitation;
(c) A mixture of butyl acrylate (36 g), 1-vinylimidazole (18.0 g) and glacial acrylic acid (36 g) were added to the kettle over a period of 3 hours at a rate of 0.475 ml/min. Simultaneously, 1-amyl peroxypivilate (Trig 125-C-75) (2 g) in 200 proof ethanol (30.2 g), DI water (30.2 g), isopropanol (95%) (1.6 g), and ammonium hydroxide (28% as ammonia) (3.3 grams) was fed to the kettle at a rate of 0.4 mL/min for a period of 3 hours. The contents were maintained at 90° C. with agitation;
(d) The product of (c) was maintained at 90° C. with constant agitation for 60 minutes;
(e) 1-amyl peroxypivilate (Trig 125-C-75) (6.0 g) in 200 proof ethanol (8.3 g), DI water (8.3 g), isopropanol (95%) (0.4 g), and ammonium hydroxide (28% as ammonia) (0.9 g) was added to the product of (d) at a rate of 0.46 mL/min for 30 minutes;
(f) The product of (e) was maintained at 90° C. with constant agitation for 30 minutes;
(g) 1-amyl peroxypivilate (Trig 125-C-75) (6.0 g) in 200 proof ethanol (8.3 g), DI water (8.3 g), isopropanol (95%) (0.4 g), and ammonium hydroxide (28% as ammonia) (0.9 g) was added to the product of (f) at a rate of 0.46 mL/min for 30 minutes;
(h) The product of (g) was maintained at 90° C. with constant agitation for 60 minutes;
(i) The heading source was removed and the product of (h) was allowed to cool to room temperature resulting in the polymer product with 20% 1-vinylimidazole at 31.2% solids referred to as Polymer 2.

### Example 3: Polymer Synthesis

A polymer product was prepared using the following process:

(a) 200 proof ethanol (56.4 g), isopropanol (95%) (3.0 g), DI water (56.4 g), ammonium hydroxide (28% as ammonia) (6.1 g), 1-vinylimidazole (.45 g), glacial acrylic acid (2.025 g), and butyl acrylate (2.025 g) was charged to a 1 liter reactor equipped with a stirrer, dropping funnel and a condenser set at −5° C.;
(b) The contents were heated to reflux at 90° C. with agitation;
(c) A mixture of butyl acrylate (40.6 g), 1-vinylimidazole (9.05 g) and glacial acrylic acid (36 g) were added to the kettle over a period of 3 hours at a rate of 0.475 mL/min. Simultaneously, 1-amyl peroxypivilate (Trig 125-C-75) (2 g) in 200 proof ethanol (30.2 g), DI water (30.2 g), isopropanol (95%) (1.6 g), and ammonium hydroxide (28% as ammonia) (3.3 grams) was fed to the kettle at a rate of 0.4 mL/min for a period of 3 hours. The contents were maintained at 90° C. with agitation;
(d) The product of (c) was maintained at 90° C. with constant agitation for 60 minutes;
(e) 1-amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.5 mL/min for 30 minutes;
(f) The product of (e) was maintained at 90° C. with constant agitation for 60 minutes;
(g) 1- amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.5 mL/min for 30 minutes;
(h) The product of (g) was maintained at 90° C. with constant agitation for 60 minutes;
(i) The heading source was removed and the product of (h) was allowed to cool to room temperature resulting in the polymer product with 10% 1-vinylimidazole at 29.5% solids referred to as Polymer 3.

### Example 4: Polymer Synthesis

A polymer product was prepared using the following process:

(a) 200 proof ethanol (56.4 g), isopropanol (95%) (3.0 g), DI water (56.4 g), ammonium hydroxide (28% as ammonia) (6.1 g), glacial acrylic acid (2.25 g), and butyl acrylate (2.25 g) was charged to a 1 liter reactor equipped with a stirrer, dropping funnel and a condenser set at −5° C.;
(b) The contents were heated to reflux at 90° C. with agitation;
(c) A mixture of butyl acrylate (47.75 g) and glacial acrylic acid (47.75 g) were added to the kettle over a period of 3 hours at a rate of 0.475 mL/min Simultaneously, 1-amyl peroxypivilate (Trig 125-C-75) (2 g) in 200 proof ethanol (30.2 g), DI water (30.2 g), isopropanol (95%) (1.6 g), and ammonium hydroxide (28% as ammonia) (3.3 grams) was fed to the kettle at a rate of 0.4 mL/min for a period of 3 hours. The contents were maintained at 90° C. with agitation;
(d) The product of (c) was maintained at 90° C. with constant agitation for 30 minutes;
(e) 1-amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.5 mL/min for 30 minutes;
(f) The product of (e) was maintained at 90° C. with constant agitation for 30 minutes;
(g) 1- amyl peroxypivilate (Trig 125-C-75) (6.3 g) in 200 proof ethanol (17.5 g), isopropanol (95%) (0.5 g), and ammonium hydroxide (28% as ammonia) (0.9 g) was added to the product of (d) at a rate of 0.5 mL/min for 30 minutes;
(h) The product of (g) was maintained at 90° C. with constant agitation for 60 minutes;
(i) The heading source was removed and the product of (h) was allowed to cool to room temperature resulting in the polymer product with 0% 1-vinylimidazole at 29.8% solids referred to as Polymer 4.

### Example 5: Polymer Synthesis

(a) DI water (84 g) was charged to a 1 liter reactor equipped with a stirrer, dropping funnel and a condenser set at 5° C.;
(b) The contents were heated at 85° C. with agitation;
(c) A mixture of DI water (46.9 g), 1-vinylimidazole (27.4 g) and PEGMA (poly(ethylene glycol) methyl ether methacrylate with Mn of about 400) (63.9 g) were added to the kettle over a period of 2 hours at a rate of 1.1 mL/min. Starting simultaneously, 2,2′-Azobis(2-methylpropionitrile) (VAZO) (3.8 g) in DI water (80.2 g) and ammonium hydroxide (28% as ammonia) (4.6 grams) was fed to the kettle at a rate of 0.47 mL/min for a period of 3 hours. The contents were maintained at 85° C. with agitation;
(d) The product of (c) was maintained at 85° C. with constant agitation for 200 minutes;
(e) The heading source was removed and the product of (d) was allowed to cool to room temperature resulting in the polymer product with 30% 1-vinylimidazole at 31.2% solids referred to as Polymer 5.

### Example 6: Polymer Synthesis

A polymer product was prepared using the following process:

(f) DI water (84 g) was charged to a 1 liter reactor equipped with a stirrer, dropping funnel and a condenser set at 5° C.;
(g) The contents were heated at 85° C. with agitation;
(h) A mixture of DI water (46.9 g), 4-vinylpyridine (27.4 g) and PEGMA 300 g/mol (63.9
(g) were added to the kettle over a period of 2 hours at a rate of 1.1 mL/min. Starting simultaneously, 2,2′-Azobis(2-methylpropionitrile) (VAZO) (3.8 g) in DI water (80.2 g) and ammonium hydroxide (28% as ammonia) (4.6 grams) was fed to the kettle at a rate of 0.47 mL/min for a period of 3 hours. The contents were maintained at 85° C. with agitation;
(i) The product of (c) was maintained at 85° C. with constant agitation for 200 minutes;
(j) The heading source was removed and the product of (d) was allowed to cool to room temperature resulting in the polymer product with 30% 4-vinylpyridine at 31.1% solids referred to as Polymer 6.

### Comparative Example 1: Polymer Synthesis

A latex copolymer was synthesized according to US20080072791A1 Example 1. The synthesis results in a latex polymer product with 30% 1-vinylimidazole at 30.0% solids referred to as Polymer 7.

### Example 8: Wood Treatment Formulations

Polymer products from Examples 1-6 and Comparative Example 1 were mixed with copper-MEA (9% copper by weight) and DI water. Solutions were observed for appearance. Only clear solutions without precipitation are compatible for pressure treating of wood. Formulations can be found in Table I.

TABLE I
Wood treatment formulations

| | Copper | Polymer | Polymer | |
|---|---|---|---|---|
| Formulation | (ppm) | Example | (wt. %) | Appearance |
| 1 | 1000 | — | 0 | Clear, blue solution |
| 2 | 0 | Example 1 | 1.6 | Clear solution |
| 3 | 1000 | Example 1 | 3.2 | Clear, blue solution |
| 4 | 1000 | Example 1 | 1.6 | Clear, blue solution |
| 5 | 1000 | Example 1 | 0.3 | Clear, blue solution |
| 6 | 1000 | Example 2 | 3.1 | Clear, blue solution |
| 7 | 1000 | Example 2 | 1.6 | Clear, blue solution |
| 8 | 1000 | Example 2 | 0.3 | Clear, blue solution |
| 9 | 1000 | Example 2 | 0.15 | Clear, blue solution |
| 10 | 0 | Example 3 | 0.3 | Clear solution |
| 11 | 1000 | Example 3 | 3.2 | Clear, blue solution |
| 12 | 1000 | Example 3 | 1.6 | Clear, blue solution |
| 13 | 1000 | Example 3 | 0.3 | Clear, blue solution |
| 14 | 1000 | Example 4 | 3.2 | Clear, blue solution |
| 15 | 1000 | Example 4 | 1.6 | Clear, blue solution |
| 16 | 1000 | Example 4 | 0.3 | Clear, blue solution |
| 17 | 1000 | Example 5 | 3.2 | Clear, blue solution |
| 18 | 1000 | Example 5 | 0.15 | Clear, blue solution |
| 19 | 1000 | Example 6 | 3.2 | Clear, blue solution |
| 20 | 1000 | Example 6 | 0.15 | Clear, blue solution |
| | | Comparative | | |
| 21 | 1000 | Comp. | 1 | White precipitate |
| | | Example 1 | | |

### Example 9: Wood Treatment with Water Soluble Polymers

Southern Yellow Pine wood cubes measuring 19 mm were weighed and measured before the treatment. Cubes were treated in one of the following two ways to achieve complete penetration and wood weight doubling.

1. Cubes were placed on top of a piece of stainless steel wire mesh in a single layer inside of a 1 L tripour beaker. A second stainless steel wire mesh was placed on top of the cubes, which was weighed down by sufficient stainless steel nuts. The tripour beaker was placed into a wood treater, and held under >28 inHg vacuum (>95 kPa) for 30 minutes. The formulation was added to the tripour beaker so that the wood and the nuts were completely submerged. The tripour beaker was held under >28 inHg vacuum for 30 minutes. The tripour beaker was removed from the treater, the cubes were removed from the solution, blotted dry, and reweighed. The cubes were allowed to dry and equilibrated to a constant weight before leaching was initiated.
2. Cubes were placed on top of a piece of stainless steel wire mesh in a single layer inside of a 1 L tripour beaker. A second stainless steel wire mesh was placed on top of the cubes, which was weighed down by sufficient stainless steel nuts. The formulation was added to the tripour beaker and then placed into a wood treater. The contents were held under >28 in Hg vacuum for 5 minutes. The pressure of the wood treater was raised to 150 psig with nitrogen, and held for 5 minutes. The pressure was released and returned to standard atmospheric pressure. The tripour beaker was removed from the treater, the cubes were removed from the solution, blotted dry, and reweighed. The cubes were allowed to dry and equilibrated to a constant weight before leaching was initiated.

### Example 10: Copper Leaching Test

The AWPA E11-97 leaching assay, with the following deviations, was used to analyze the leachate for copper contents. The control was 1000 ppm Cu from copper monoethanolamine complex.

1. Only one copper/polymer treatment level (where copper metal was set at 1000 ppm) was evaluated for each combination.
2. No retention analysis (for mass balance) was performed of untreated or treated cubes.

The results are presented in Table II. Polymers in the wood treatments are presented as weight percent of the polymer example in the final solution.

TABLE II
Copper leaching

| | Total Cu leached |
|---|---|
| Wood treatment | relative to control |
| Formulation 3 | 464% |
| Formulation 4 | 432% |
| Formulation 5 | 91% |
| Formulation 6 | 443% |
| Formulation 7 | 34% |
| Formulation 8 | 19% |
| Formulation 9 | 78% |
| Formulation 11 | 133% |
| Formulation 12 | 46% |
| Formulation 13 | 63% |
| Formulation 14 | 238% |
| Formulation 15 | 71% |
| Formulation 16 | 76% |

1. A method for treating wood; said method comprising adding to wood: (a) a copper-containing wood preservative; and (b) a solution copolymer which is an acrylic polymer comprising from 5 to 40 wt % polymerized units of a nitrogen heterocycle monomer and from 30 to 80 wt % polymerized units of a monomer comprising at least one acid group or comprising at least 2 polymerized units of ethylene oxide.

2. The method of claim 1 in which the nitrogen heterocycle monomer is an aromatic nitrogen heterocycle having from four to ten carbon atoms.

3. The method of claim 2 in which the monomer comprising at least one acid group is a carboxylic acid monomer having from three to six carbon atoms.

4. The method of claim 3 in which the copper-containing wood preservative and the solution copolymer are added to the wood together in an aqueous solution.

5. The method of claim 4 in which the acrylic polymer comprises from 8 to 35 wt % polymerized units of a nitrogen heterocycle monomer, from 33 to 55 wt % polymerized units of a monomer comprising at least one acid group and from 20 to 55 wt % polymerized units of additional monomers which are vinyl esters or acrylic monomers not having an acid group or nitrogen heterocycle, and which have from three to ten carbon atoms.

6. The method of claim 5 in which the acrylic polymer has a weight-average molecular weight from 1,000 to 70,000.

7. The method of claim 6 in which the nitrogen heterocycle monomer is 1-vinylimidazole.

8. The method of claim 7 in which said additional monomers are C₁-C₄ alkyl acrylates.

9. The method of claim 4 in which the acrylic polymer comprises from 8 to 35 wt % polymerized units of a nitrogen heterocycle monomer and from 40 to 80 wt % polymerized units of a monomer comprising from 2 to 20 polymerized units of ethylene oxide.
